(19) United States
(12) Patent Application Publication
(10) Pub. No.: US 2008/0248194 A1
(43) Pub. Date: Oct. 9, 2008

(54) METHOD FOR PRODUCING A COPPER LAYER ON A SUBSTRATE IN A FLAT PANEL DISPLAY MANUFACTURING PROCESS

(75) Inventors: Akinobu NASU, AkatsukaTsukuba (JP); Shyuan-Fang Chen, Hsinchu (TW); Wen-Jin Li, Tapei City (TW); Yi-Tsung Chen, Hsinchu (TW)

Correspondence Address: AIR LIQUIDE;Intellectual Property, 2700 POST OAK BOULEVARD, SUITE 1800, HOUSTON, TX, 77056, US

(73) Assignee: L'Air Liquide - Societe Anonyme pour l'Etude et l'Exploitation des Procedes Georges Claude, Paris (FR)

(21) Appl. No.: 11/948,320

(22) Filed: Nov. 30, 2007

Related U.S. Application Data
(60) Provisional application No. 60/910,091, filed on Apr. 4, 2007.

(51) Int. Cl. B05D 5/12

(52) U.S. Cl. 427/123

(57) ABSTRACT

Methods and apparatus for producing a copper layer on substrate in a flat panel display manufacturing process, where the copper is electrodelessly deposited on a substrate to form a copper interconnection layer. A copper solution containing: CuSO₄ 5H₂O as a copper source, potassium sodium tartrate or trisodium citrate as a complexing agent, glyoxylate, glyoxilic acid or sodium phosphate as a reducing agent, a sulfur organic compound as a stabilizing agent, and a pH adjusting agent, is used to form the copper interconnection layer on the substrate.

### CROSS REFERENCE TO RELATED APPLICATIONS

The present application claims the benefit of U.S. Provisional Application Ser. No. 60/910,091, filed Apr. 4, 2007, herein incorporated by reference in its entirety for all purposes.

### BACKGROUND

1. Field of the Invention

This invention relates generally to the field of TFT-LCD flat panel display manufacturing. More specifically, the invention relates to a method of depositing a copper interconnection layer on a substrate.

2. Background of the Invention

Various etching processes are used to make transistors. However, dry etching of copper is not effective because most of copper species are not volatile and/or etching gas and by-products are corrosive in most cases. In the semiconductor industry, the damascene process has been developed, wherein a via-hole is made first then copper is filled into the hole by combination of dry (sputtering) and wet processes (electroplating). In the flat panel display industry, the use of copper is considered to reduce the signal delay as in the semiconductor industry, but the damascene method is not considered as appropriate since such process requires many more steps than the current wiring process, and it has not been consistently effective with large substrates (e.g. 1.5 m×1.8 m for G5 TFT-LCD panel). It is anticipated that the use of such process would raise some technical hurdles and increase the manufacturing cost. On the other hand, wet etching of copper is also studied. However, it is more difficult to control the shape of the copper interconnections because wet etching is not anisotropic but isotropic.

Electrodeless copper plating has a long history in the PCB (printed circuit board) industry, and the plating technology itself has already matured. The plating gives conformal, high quality copper at a relatively low cost and a low process temperature. Many copper solutions are commercially available for copper interconnection. Most conventional copper solutions contain formalin as a reducing agent and/or ethylenediaminetetraacetic acid (or “EDTA”) as a complexing agent, On an environmental, health and safety (EHS) basis, formalin is a product which usage should be minimized, because it is known to be a carcinogenic product for human being. To make it more effective it is recommended to heat the solution containing such product, so as to enhance the plating rate of copper. However it is highly volatile already at ambient temperature and the risk for human being is increased when heating it.

EDTA is also a product of concern for different reasons: EDTA is able to form a stable complex, which is difficult to handle with the waste treatment device. The use of this product is limited because it is necessary to use a large amount of an oxidizing agent to decompose such stable complex. However the use of EDTA for TFT-LCD manufacture would require a much too large amount of oxidizing agent which would render this process too expensive.

These commercially available copper solutions are not satisfactory for TFT-LCD application because the interconnections obtained have a poor thickness uniformity, a poor adhesion to the base layer, a high surface roughness and/or a lack of plating reproducibility.

Consequently, there exists a need for copper plating solutions for TFT-LCD copper interconnections which are more environmental friendly than the existing ones and which do not have the drawbacks of the solutions presently on use for the same application.

### BRIEF SUMMARY

Novel methods for producing a copper plated substrate in a flat panel TFT-LCD manufacturing environment are described herein.

In an embodiment, a method of producing a copper plated substrate, for use in manufacturing a flat panel display device where the method comprises providing a substrate, and providing a catalyzation layer onto part of the substrate. A copper layer is then electrodelessly applied to at least the catalyzed portion of the substrate by exposing this portion to a copper solution. The copper solution comprises CUSO₄ 5H₂O as a copper source; a complexing agent which may include potassium sodium tartrate 4H₂O or trisodium citrate 2H₂O; a reducing agent which may include glyoxylate, glyoxilic acid, or sodium phosphate H₂O; a sulfur organic compound as a stabilizing agent; and a pH adjusting agent to adjust the pH of the solution, at room temperature, to between 9 and 12.5.

Other embodiments of the current invention may include, without limitation, one or more of the following features:
the catalyzation layer is conditioned at a temperature between about 15° C. and about 35° C., and for a length of time between about 5 seconds and about 3 minutes;
the copper plated substrate is annealed by heating the substrate under an atmosphere comprising between about 1% to about 3%, by volume, of hydrogen (nitrogen balanced);
an oxidation limiting capping layer is provided on the copper layer, wherein the capping layer is an NiP or NiXP layer (where X is a refractory metal selected from W, Mo, or Re), and the capping layer is between about 100 nm and about 300 nm thick;
the catalyzation layer is provided by providing a thin catalytic silver layer on the base layer by exposing the base layer to a mixture of AgNO₃ in NH₄OH solution, wherein the mixture comprises about 0.1 g/L to about 10 g/L of AgNO₃ in about 0.01% to about 1% NH₄OH solution, and more preferably the mixture comprises about 1 g/L to about 5 g/L of AgNO₃ in about 0.1% to about 0.5% NH₄OH solution;
the catalyzation layer is provided by providing a thin catalytic palladium layer on the base layer by exposing the base layer to a mixture of (NH₃)₄PdCl₂ in NH₄OH solution, wherein the mixture comprises about 0.1 g/L to about 1.0 g/L of (NH₃)₄PdCl₂ in about 0.01% to about 1% NH₄OH solution and more preferably the mixture comprises about 0.3 g/L to about 0.7 g/L of (NH₃)₄PdCl₂ in about 0.01% to about 1% NH₄OH solution;
the copper plating solution further comprises between about 0.1 g/L to about 10 g/L of NiSO₄ 6H₂O,
the catalyzation layer is conditioned by exposing it to a mixture comprising between about 0.01% to about 5%, more preferably between about 0.1% to about 2%, of glyoxylate or phosphinate in solution:
the catalyzation layer is conditioned by exposing it to a mixture comprising between about 0.1 g/L to about 5 g/L, more preferably between about 0.5 g/L to about 3 g/L, of dimethylamineborane (DMAB) in solution;
the copper solution comprises between about 2 g/L to about 15 g/L of CuSO₄ 5H₂O;
the copper solution comprises between about 40 g/L to about 100 g/L, more preferably between about 65 g/L to about 85 g/L, of potassium sodium tartrate 4H₂O;
the copper solution comprises between about 10 g/L to about 100 g/L, more preferably between about 50 g/L to about 90 g/L of trisodium citrate 2H₂O;
the copper solution comprises between about 0.01% to about 5%, by volume, of glyoxylate or glyoxilic acid;
the copper solution comprises between about 5 g/L to about 50 g/L of sodium phosphinate;
the stabilizing agent comprises about 1 ppb and about 100 ppb of thiourea;
the copper layer is provided substantially at room temperature, preferably between about 15° C. and about 35° C., without heating the copper solution; and
the copper layer is provided by a copper solution which contains no formalin or ethylenediaminetetraacetic acid (EDTA).

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and the specific embodiments disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a further understanding of the nature and objects for the present invention, reference should be made to the following detailed description, taken in conjunction with the accompanying drawings, in which like elements are given the same or analogous reference numbers and wherein:

FIG. 1 illustrates a schematic representation of one embodiment according to the current invention for providing a copper layer on a substrate.

### DESCRIPTION OF PREFERRED EMBODIMENTS

Generally, the invention relates to a method of producing a copper plated substrate, for use in manufacturing a flat panel display device, where the method comprises providing a substrate, and providing a catalyzation layer onto part of the substrate. A copper layer is then electrodelessly applied to at least the catalyzed portion of the substrate by exposing this portion to a copper solution. The copper solution comprises CuSO₄ 5H₂O as a copper source; a complexing agent which may include potassium sodium tartrate 4H₂O or trisodium citrate 2H₂O; a reducing agent which may include glyoxylate, glyoxilic acid, or sodium phosphate H₂O; a sulfur organic compound as a stabilizing agent; and a pH adjusting agent to adjust the pH of the solution, at room temperature, to between 9 and 12.5.

In some embodiments, the catalyzation step is performed at room temperature in the range of 15° C. to 35° C. In one embodiment, AgNO₃ in an NH₄OH solution can be used to make thin catalytic silver layer on a base layer (where the base layer may be a NiP and NiXP layer, with X being a refractory metal such as W, Mo, Re) deposited on the substrate prior to catalyzation. For example, 0.1 g/L to 10 g/L of AgNO₃ in 0.01% to 1% NH₄OH solution is used; more preferably a solution comprising 1 g/L to 5 g/L of AgNO₃ in 0.1% to 0.5% NH₄OH solution is used.

In another embodiment, (NH₃)₄PdCl₂ in an NH₄OH solution may be used to carry out a thin catalytic palladium layer on the NiP or NiXP base layer. For example, a 0.1 g/L to 1 g/L of (NH₃)₄PdCl₂ in 0.01% to 1% NH₄OH solution is used, more preferably 0.3 g/L to 0.7 g/L of (NH₃)₄PdCl₄ in 0.1% to 0.5% NH₄OH solution. Each catalyzation step may be done for a suitable time such as 5 sec to 3 min. Then, it is rinsed with DIW (de-ionized water).

In some embodiments, the catalyzation layer may be conditioned by exposing the catalyzation layer to a conditioning solution. This step is usually done at room temperature in the range of 15° C. to 35° C., and for a length of time between about 10 seconds and about 5 minutes. According to one embodiment, a solution comprising 0.01% to 5%, more preferably 0.1% to 2% of glyoxylate or phosphinate may be used as the conditioning solution. According to another embodiment, a solution comprising 0.1 g/L to 5 g/L, more preferably 0.5 g/L to 3 g/L, of DMAB (dimethylamineborane) solution may be used as the conditioning solution.

In some embodiments, the copper plating solution comprises between 2 g/L to 15 g/L of CuSO₄ 5H₂O as a copper source. This solution may also comprise a complexing agent such as tartrate or citrate compounds. For example, the solution may contain between 40 g/L to 100 g/L of potassium sodium tartrate 4H₂O or between 10 g/L to 100 g/L of tri-sodium citrate 2H₂O.

In some embodiments, the copper solution may also comprise a reducing agent selected from the group of glyoxylate and phosphinate compounds. For example, the solution may contain between 0.01% to 5% of glyoxylic acid or 5 g/L to 50 g/L of sodium phosphinate H₂O.

In some embodiments, a nickel compound may be added to the solution to promote copper plating. For example, the solution may contain between 0.1 g/L to 10 g/L of NiSO₄ 6H₂O. The solution may also contain a sulfur organic compound which acts as a stabilizer. For example, the solution may contain between about 1 ppb and about 100 ppb of thiourea. The pH of the solution may be adjusted to the range of 9 to 12.5 by using an alkaline solution such as NaOH or NH₄OH.

When the copper solution is applied to at least part of the catalyzed layer, it may be applied electrodelessly in that the plating occurs through contact, without an electrode. The plating time is usually determined by the required thickness, and the time is usually in the range of 1 min to 60 min, more preferably, 3 min to 30 min to obtain a few hundred nanometers of copper layer. Then the substrate may be rinsed with DIW to remove excess copper solution.

In some embodiments, the substrate may be annealed after the copper layer is applied. The sample can be heated in a conventional manner after the copper plating step has been carried out, for example, at 400° C. for 1 hour or 150° C. for 3 hours. The annealing may be performed under an atmosphere comprising 1-10% hydrogen the balance as nitrogen, at atmospheric or vacuum pressure.

In some embodiments, a capping layer may be added over the copper layer in order to avoid any chemical reaction (i.e., oxidation) of the copper layer. According to one embodiment, 10 nm to 300 nm of NiP or NiXP (where X is a refractory metal such as W, Mo, Re) may be electrodelessly applied over the copper layer.

In some embodiments, the copper plating solution is prepared and the copper layer is provided under temperature conditions near room temperature (e.g. between about 15° C. and about 35° C.).

In some embodiments, the copper plating solution does not contain formalin, a known carcinogenic substance which has known environmental, health and safety issues. Likewise, the copper plating solution does not contain ethylenediaminetetraacetic acid (EDTA), another substance, commonly used as a complexing agent, which poses numerous safety concerns.

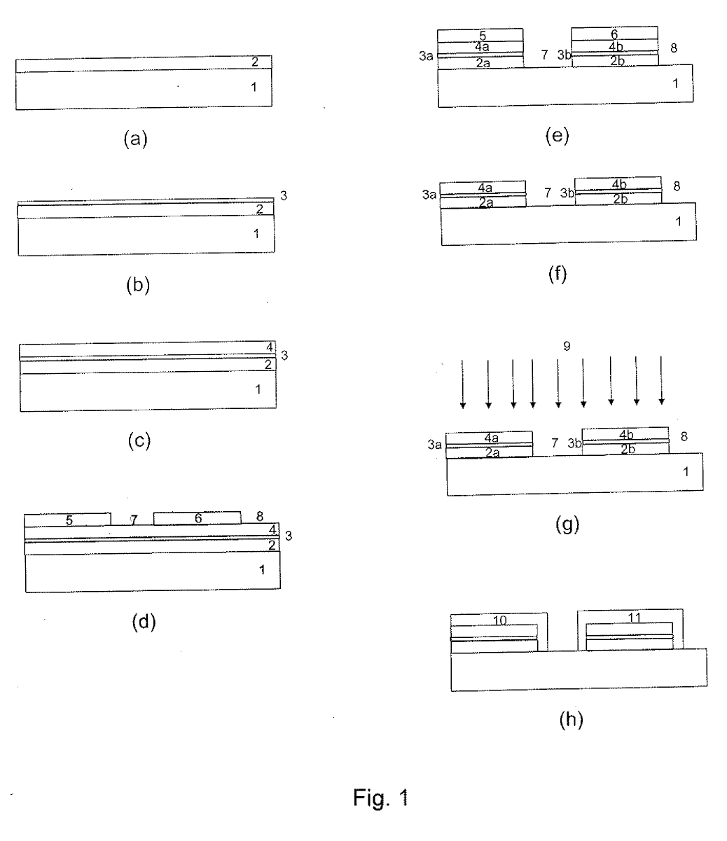

Referring now to FIG. 1, embodiments of a method, according to the current invention, to provide a copper layer on a substrate, for use in manufacturing a flat panel display device are described hereafter. Generally, FIG. 1 shows a representation of several steps in the flat panel manufacturing process and reference letters (a)-(h) designate one chronological sequence for these steps.

In one embodiment, a substrate 1 is provided upon which a base layer 2 of either NiP or NiPX is then provided. A catalyzation layer 3, which is typically thinner than the base layer 2, is provided over top of the base layer 2. The catalyzation layer 3 may then be optionally conditioned. A copper layer 4 may then electrodelessly be deposited on top of catalyzation layer 3. Typically, the copper layer is provided by contacting at least a portion of the catalyzed layer with a copper plating solution. As according to methods known to one of skill in the art, a pattern of photo resist 5 is deposited on the copper layer 4, to delineate a pattern of trenches 7 and 8. Also according to methods known to one of skill in the art, the layers 2, 3, and 4 located under the trenches 7 and 8 are then removed by a wet-etching solution. The remaining parts of layers 5 and 6 are then dissolved to provide two stacks of interconnection tracks, respectively 2a, 3a, 4a and 2b, 3b and 4b on the substrate 1. The substrate 1 and the tracks may then be heat treated by a heat source 9. The interconnection tracks may then be capped with a protection layer 10 and 11.

### EXAMPLES

The following non-limiting examples are provided to further illustrate embodiments of the invention. However, the examples are not intended to be all inclusive and are not intended to limit the scope of the inventions described herein.

### Example 1

Prior to copper plating, a 50 nm NiP layer was plated on the base substrate using a well known electrode less plating method. The sample was then immersed into an AgNO₃ solution (1.5 g/L AgNO₃ in 0.3% NH₄OH) for 30 sec, then rinsed with de-ionized water (DIW) and dipped into a copper plating solution comprising:

a) CuSO₄ 5H₂O: 7.5 g/L;

b) C₄H₄KNaO₆ 5H₂O: 85 g/L;

c) NiSO₄ 6H₂O: 1 g/;

d) glyoxylic acid: 0.8% wt; and

e) thiourea: 5 ppb.

The pH of the solution was adjusted to 12 with NaOH and the solution maintained at room temperature.

The sample was then annealed under a H₂/N₂ atmosphere (1%-99%) at 150° C. for 3 hours. The plated copper on the NiP layer exhibited a good adhesion to the base substrate. A surface analysis made by Atomic Force Microscope (AFM) showed a small roughness. A depth profile analysis made by Auger Electron Spectrometry (AES) showed only slight impurities in the copper layers.

### Example 2

A copper solution comprising 60 g/l of C₄H₄KNaO₆ 5H₂O and having a pH of 11.5 has been used, all other conditions being the same as in Example 1. The plated copper on the NiP layer exhibited a good adhesion to the base substrate. Surface analysis by AFM showed small roughness. Depth profile analysis by AES showed only slight impurities in the copper layer.

### Example 3

The copper plating step was carried out in the same conditions as in Example 1 except that the concentration of the glyoxylic acid concentration was 0.2%. The plated copper on NiP layer exhibited a good adhesion to the base substrate. Surface analysis by AFM showed small roughness. Depth profile analysis by AES showed only slight impurities in the copper layers. The decrease of the reducing agent concentration (glyoxylic acid) resulted in a lower plating rate.

### Example 4

The copper plating step was carried out in the same conditions as in Example 1 except that the pH of the solution was maintained to 11.0 and that the glyoxylic acid concentration was 1.8%. (Higher glyoxylic acid concentration enhanced the plating rate). The plated copper on NiP layer exhibited a good adhesion to the base substrate. Surface analysis by AFM indicated a small roughness. Depth profile analysis by AES showed only slight impurities in the copper layers.

### Example 5

The copper plating step was carried out in the same conditions as in Example 1 except that a 50 nm of NiXP (X is W, Mo or Re) instead of the NiP was plated on the substrate prior to the copper plating step. The plated copper on NiXP layer exhibited a good adhesion to the base substrate. Surface analysis by AFM showed small roughness. Depth profile analysis by AES showed only slight impurities in the copper layers.

### Example 6

Prior to copper plating, a 50 nm NiP layer was plated on the base substrate using a well-known electrodeless plating method. The sample was then immersed into a (NH₃)₄PdCl₂ solution (0.6 g/L (NH₃)₄PdCl₂ in 0.2% NH₄OH) for 2 min, then dipped into a copper plating solution comprising:

a) CuSO₄ 5H₂O: 6.0 g/L;

b) Na₃C₆H₅O₇2H₂O: 15.3 g/L;

c) NiSO₄ 6H₂O: 0.5 g/L; and

d) NaH₂PO₂H₂O: 28.6 g/L.

The pH of the solution was adjusted to 9.5 with H₃BO₃ and NaOH buffer addition and maintained at 65° C.

Copper was plated on the NiP layer, and the copper layer exhibited good properties as in examples 1 to 5.

Comparative examples were carried out in the same conditions as in Example 1 with the following differences:

### Comparative Example 1

Copper was tentatively plated on the base substrate without prior deposition of a NiP or NiXP layer. Copper deposition was observed with a poor uniformity and/or a poor adhesion to the substrate.

### Comparative Example 2

Copper was plated on the base substrate without carrying out the catalyzation step. No copper deposition was observed.

In a similar way, when the catalyzation step was carried out with AgNO₃ and/or NH₄OH concentrations out of the ranges 0.1 g/l to 10 g/l for AgNO₃ and 0.01% to 1% for NH₄OH respectively, the reproducibility of the copper layer deposition was not satisfactory.

### Comparative Example 3

Copper was tentatively plated on the base substrate with a glyoxylic acid concentration below 0.01%. Either the plating rate observed was too low or no copper deposition was carried out. Conversely, when the glyoxylic acid concentration was increased above 5%, the plating rate remained good, but the solution became unstable and decomposed quickly.

### Comparative Example 4

No sulfur organic compound was added into the copper solution. There was no marked change on copper deposition or uniformity or adhesion of the copper layer on the substrate. However, the copper solution became more unstable and decomposed in a short time. Conversely, when the sulfur organic compound concentration was higher than 100 ppb, the plating rate became too slow to get a suitable thickness of the copper layer.

### Comparative Example 5

The copper solution was heated at a temperature above 35° C. The plating rate was still good enough, but the solution became unstable and decomposed quickly.

### Comparative Example 6

The concentration of C₄H₄KNaO₆ 5H₂O was maintained below 40 g/L, but then the copper solution generated randomly unexpected precipitations very quickly. Conversely, when the concentration of the product was maintained above 100 g/L, the plating reproducibility became poorer.

### Comparative Example 7

The pH of the copper solution was adjusted below 9. No copper plating was observed. On the other hand, when the pH was maintained above 12.5 the, plating rate became high, but poorer adhesion of the copper layer and shorter shelf life of the solution were observed.

While embodiments of this invention have been shown and described, modifications thereof can be made by one skilled in the art without departing from the spirit or teaching of this invention. The embodiments described herein are exemplary only and not limiting. Many variations and modifications of the composition and method are possible and within the scope of the invention. Accordingly the scope of protection is not limited to the embodiments described herein, but is only limited by the claims which follow, the scope of which shall include all equivalents of the subject matter of the claims.

What is claimed is:

1. A method for producing a copper layer on a substrate for use in manufacturing a flat panel display device, by electrodelessly depositing a copper interconnection layer on a substrate, comprising:
a) providing a substrate;
b) providing a catalyzation layer onto at least part of the substrate; and
c) providing a copper layer on at least part of the catalyzed portion of the substrate, by exposing the catalyzed portion to a copper solution and thereby forming a copper plated substrate, wherein the copper solution comprises:
1) CuSO₄ 5H₂O as a copper source;
2) a complexing agent, comprising potassium sodium tartrate 4H₂O or trisodium citrate 2H₂O;
3) a reducing agent, comprising at least one member selected from glyoxylate, glyoxilic acid or sodium phosphate H₂O;
4) a stabilizing agent comprising a sulfur organic compound; and
5) a pH adjusting agent to adjust the pH of the copper solution, at room temperature, to between 9 and 12.5.

2. The method of claim 1, further comprising conditioning the catalyzation layer prior to providing the copper layer, wherein the conditioning is performed at a temperature between about 15° C. and about 35° C., and wherein the conditioning takes place over a time period between about 5 seconds to about 3 minutes.

3. The method of claim 1, further comprising annealing the copper plated substrate, wherein the annealing comprises heating the substrate under an atmosphere comprising between about 1% and about 3%, by volume, of hydrogen (nitrogen balanced).

4. The method of claim 1, further comprising providing an oxidation limiting capping layer on the copper layer, wherein:
a) the capping layer is an NiP or NiXP layer, wherein X is a refractory metal selected from the group consisting of W, Mo, and Re; and
b) the capping layer is between about 10 nm and about 300 nm thick.

5. The method of claim 1, further comprising providing a base layer on the substrate, prior to providing the catalyzation layer, wherein the base layer comprises a NiP or NiXP layer and X is a refractory metal selected from the group consisting of W, Mo, and Re.

6. The method of claim 5, wherein providing the catalyzation layer comprises providing a thin catalytic silver layer on the base layer by exposing the base layer to a mixture of AgNO₃ in NH₄OH solution, wherein the mixture comprises about 0.1 g/L to about 10 g/L of AgNO₃ in about 0.01% to about 1% NH₄OH solution.

7. The method of claim 5, wherein providing the catalyzation layer comprises providing a thin catalytic palladium layer on the base layer by exposing the base layer to a mixture of (NH₃)₄PdCl₂ in NH₄OH solution, wherein the mixture comprises about 0.1 g/L to about 1.0 g/L of (NH₃)₄PdCl₂ in about 0.01% to about 1% NH₄OH solution.

8. The method of claim 1, wherein the copper plating solution further comprises between about 0.1 g/L to about 10 g/L of NiSO₄ 6H₂O.

9. The method of claim 2, further comprising conditioning the catalyzation layer by exposing it to a conditioning mixture comprising between about 0.01% to about 5% of glyoxylate or phosphinate in solution.

10. The method of claim 2, further comprising conditioning the catalyzation layer by exposing it to a conditioning mixture comprising between about 0.1 g/L to about 5 g/L of dimethylamineborane (DMAB) in solution.

11. The method of claim 1, wherein the copper solution comprises between about 2 g/L to about 15 g/L of CuSO₄ 5H₂O.

12. The method of claim 1, wherein the copper solution comprises between about 40 g/L to about 100 g/L of potassium sodium tartrate 4H₂O.

13. The method of claim 12, wherein the copper solution comprises between about 65 g/L to about 85 g/L of potassium sodium tartrate 4H₂O.

14. The method of claim 1, wherein the copper solution comprises between about 10 g/L to about 100 g/L of trisodium citrate 2H₂O.

15. The method of claim 14, wherein the copper solution comprises between about 50 g/L to about 90 g/L of trisodium citrate 2H₂O.

16. The method of claim 1, wherein the copper solution comprises between about 0.01% to about 5%, by volume, of glyoxylate or glyoxilic acid.

17. The method of claim 1, wherein the copper solution comprises between about 5 g/L to about 50 g/L of sodium phosphinate.

18. The method of claim 1 wherein the stabilizing agent comprises between about 1 ppb and about 100 ppb of thiourea.

19. The method of claim 1, further comprising providing the copper layer at room temperature without heating the copper solution.

20. The method of claim 1, further comprising providing the copper layer with a copper solution which contains no formalin or ethylenediaminetetraacetic acid (EDTA).
